(19) United States
(12) Patent Application Publication
(10) Pub. No.: US 2014/0346835 A1
(43) Pub. Date: Nov. 27, 2014

(54) STANDING SUPPORT APPARATUS

(71) Applicants: Scott David Baznik, Iva, SC (US); Steve Sanford Camp, Hawthorne, FL (US)

(72) Inventors: Scott David Baznik, Iva, SC (US); Steve Sanford Camp, Hawthorne, FL (US)

(21) Appl. No.: 14/280,899

(22) Filed: May 19, 2014

Related U.S. Application Data
(60) Provisional application No. 61/827,289, filed on May 24, 2013.

(51) Int. Cl. B60N 2/64; B63B 29/04

(52) U.S. Cl. CPC B60N 2/64; B63B 29/04; B63B 2029/043
USPC 297/452.39

(57) ABSTRACT

A standing support apparatus for a standing person, comprising: a mounting platform, for mounting the seat to a pedestal; a back support, configured for contacting a standing person; a first arm terminating in a first personal retention hook; and a second arm terminating in a second personal retention hook, wherein the back support, the first arm, the second arm, the first personal retention hook, and the second personal retention hook are mechanically coupled to each other and define a space for the torso of a standing person at hip height and configured for retaining a standing person in the space.

### CROSS REFERENCE TO RELATED APPLICATION

This application claims the priority benefit of the earlier filing date of U.S. Provisional Application No. 61/827,289, filed May 24, 2013, which is hereby specifically incorporated herein by reference in its entirety.

### FIELD OF THE DISCLOSURE

The present disclosure relates generally to a personal retaining device that is particularly suitable for installation on watercraft and in particular, a modified boat seat that offers stability while in the standing position.

### BACKGROUND

Maintaining balance in a standing position over a changing surface is a problem often encountered by a fisherman when standing in a watercraft, for example as waves lap against the hull of the watercraft compromising the safety of the fisherman and any other occupants of the watercraft. This problem can be compounded when the fisherman is operating a foot-controlled trolling motor while fishing.

Typically, the fisherman is trying to accomplish control of the craft without any type of brace (for example free-standing), or using a boat seat mounted at just below hip level to lean against. A drawback of this situation is that when a fisherman is operating a foot controlled trolling motor without any type of brace, the time available to fish can be limited, for example because waves may be of sufficient strength to make the boat too unstable for standing.

In the situation where a fisherman is leaning against a hip-level boat seat and operating a foot-controlled trolling motor, some backward stability is provided by this configuration, however little lateral or forward stability is available. For example U.S. Pat. No. 7,789,035 to Rosenberg et al., U.S. Pat. No. 5,784,983 to Stegall, and U.S. Pat. No. 4,803,945 to Adams et al. provide back braces to lean against while fishing. However, the disclosed devices do not provide any lateral or forward support. Similarly, while U.S. Pat. No. 7,252,336 to Frisina provides an articulating boat seat, this seat does not provide any forward and lateral stability.

Thus, there remains a need for a device, that provides stability in forward and backward motion, as well as laterally, while allowing hands and legs free to fish and control a trolling motor. The present disclosure meets this need.

### SUMMARY

Aspects of the present disclosure concern a standing support apparatus for a standing person. The standing support apparatus includes a mounting platform, for mounting the seat to a pedestal; a back support, configured for contacting a standing person; a first arm terminating in a first personal retention hook; and a second arm terminating in a second personal retention hook. The back support, the first arm, the second arm, the first personal retention hook, and the second personal retention hook, mechanically couple and define a space for the torso of a standing person at hip height and are configured for retaining a standing person in the space.

Aspects of the present disclosure further concern a standing support apparatus that is comprised of a first plate and a second plate separated by a center support frame, wherein the first plate is coupled to the center support frame at a first side and the second plate is coupled to the center support frame at a second side, opposite the first side. In certain examples, the first plate, second plate, and center support frame are of the same outline. In certain examples, the center support frame is substantially hollow within the outline.

Aspects of the present disclosure concern a modified fishing seat, comprising: a mounting platform, for mounting the seat to a pedestal; a back support, configured for contacting a standing person; a first arm; and a second arm, wherein the first arm comprises a first personal retention hook and the second arm comprises a second personal retention hook. The back support, the first arm, the second arm, the first personal retention hook, and the second personal retention hook, defining a space for the torso of a standing person at hip height and configured for retaining a standing person in the space.

The foregoing and other features will become more apparent from the following detailed description of several embodiments, which proceeds with reference to the accompanying figures.

### BRIEF DESCRIPTION OF THE DRAWINGS

FIG. 1 is a top perspective view of an exemplary standing support apparatus, in accordance with certain example embodiments.

FIG. 2 is a bottom perspective view of an exemplary standing support apparatus, rotated 180° about the front to back axis, in accordance with certain example embodiments.

FIG. 3 is a side perspective view of an exemplary standing support apparatus, in accordance with certain example embodiments.

FIG. 4 is a front perspective view of an exemplary standing support apparatus, in accordance with certain example embodiments.

FIG. 5 is a back perspective view of an exemplary standing support apparatus, in accordance with certain example embodiments.

FIG. 6 is an exploded perspective view of an exemplary standing support apparatus, in accordance with certain example embodiments.

FIG. 7 is a perspective view of an exemplary standing support apparatus including a pedestal.

FIG. 8 is a top down view of an exemplary standing support apparatus with exemplary dimensions included.

### DETAILED DESCRIPTION OF SEVERAL EMBODIMENTS

The description proceeds with reference to several exemplary embodiments. The present invention is directed toward novel and non-obvious features and methods acts disclosed herein both alone and in various combinations and subcombinations with one another as set forth in the claims.

As used herein, the singular forms “a,” “an,” and “the” refer to one or more than one, unless the context clearly dictates otherwise.

As used herein, the term “includes” means “comprises.” For example, a device that includes or comprises A and B contains A and B but may optionally contain C or other components other than A and B. A device that includes or comprises A or B may contain A or B or A and B, and optionally one or more other components such as C.

This disclosure addresses the problem where a person needs to stand in unstable environment while having hands and legs available to perform tasks and maintain balance. For example, such tasks can include operating a foot-controlled trolling motor on a fishing boat when waves or submerged stumps can cause the boat to be unstable, or standing in the bed of a slow moving vehicle, such as pickup truck, while the vehicle experiences bumps in the road.

Disclosed herein is an apparatus for supporting a person while standing, such as standing while hunting, fishing, shooting or any activity that would benefit from being stabilized while standing, but not strapped into a harness. For example in the situation where one is fishing, a harness might prevent egress from an unintentional capsize, and cause injury to the person. The present disclosure avoids such a situation by providing an apparatus that can retain a person, but still allows for easy egress in case of emergency.

The disclosed apparatus is generally “C” or horseshoe shaped and can be mounted substantially parallel to the ground with a flat surface towards the back for attaching a support such as a seat pedestal. When the stability apparatus is mounted to an up/down adjustable support pedestal, the top of the flat surface can be used as a seat when in the lower position. The “C” shape of the stability apparatus is open to allow a person sideway entry, yet specifically narrow enough and mounted at an optimal height to hold a person in place at the hips when facing forward.

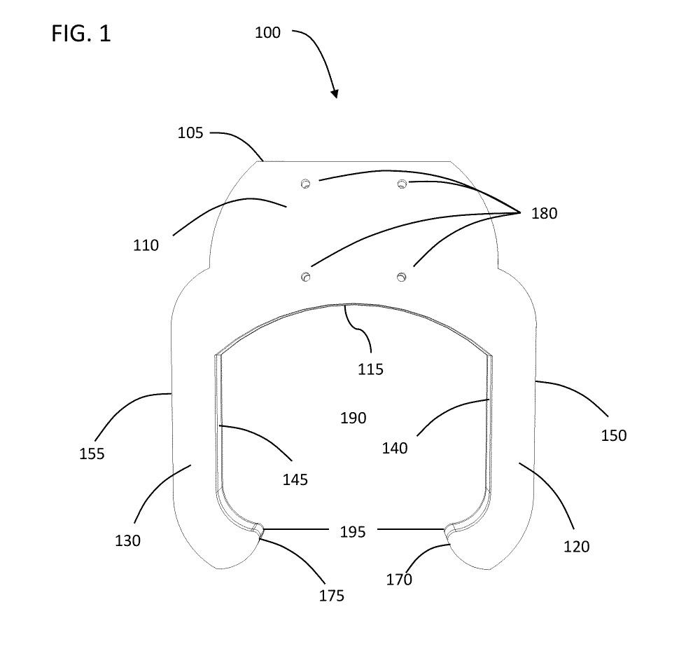

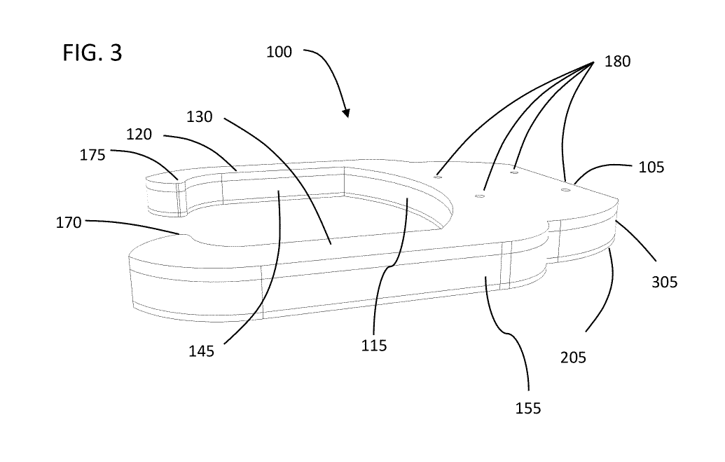

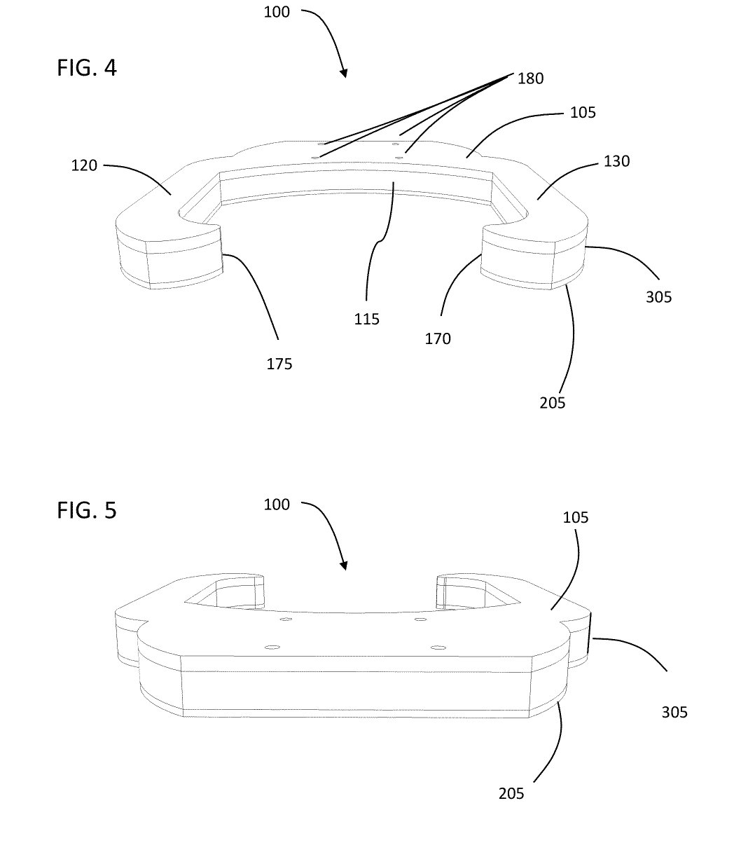

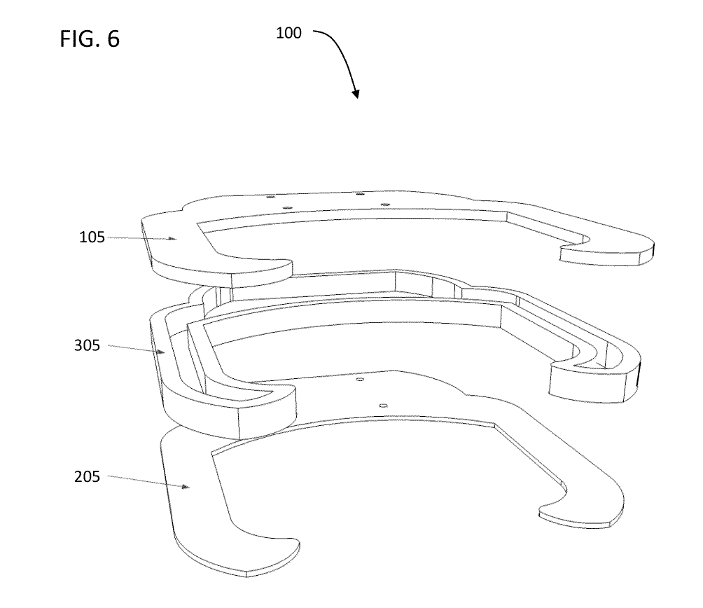

Referring first to FIGS. 1-6, there is shown standing support apparatus 100 according to one embodiment first plate 105 comprises mounting platform 110, for mounting standing support apparatus 100, for example to a preexisting pedestal, such as a boat seat pedestal; back support 115, configured for contacting a standing person; first arm 120; and second arm 130.

First arm 120 includes first internal personal positioning surface 140 and first outer surface 150 and terminates in first personal retention hook 170. Second arm 130 includes second personal positioning surface 145 and second outer surface 155 and terminates in second personal retention hook 175.

Taken together, back support 115, first arm 120 first personal positioning surface 140, second arm 130 personal positioning surface 145, first personal retention hook 170, and second personal retention hook 175, define space 190 with opening 195, that is configured to position axially the torso of a standing person at hip height and is further configured to retain a standing person, or the torso thereof, in space 190. By way of example, using standing support apparatus 100 mounted at hip level on a vehicle or watercraft, such as a boat, is done by standing sideways in front of standing support apparatus 100 opening 195 then moving sideways into the center of space 190 of standing support apparatus 100. Once inside space 190 of standing support apparatus 100, a person swivels to position hips in a forward posture that will prevent movement out of the support apparatus 100 opening 195. In one embodiment a person would face opening 195 with their hip bones retained against forward movement by first personal retention hook 170, and second personal retention hook 175, side to side movement retained by first personal positioning surface 140, and second internal personal positioning surface 145 and backward movement retained by back support 115. It is envisioned however that based on personal preference a person may opt to enter standing support apparatus 100 essentially backwards, such that they can lean forward against back support 115 and have first personal retention hook 170 and second personal retention hook 175 prevent backward movement. It is further envisioned that in some circumstances the height of standing support apparatus 100 can be adjusted such that a person can use the apparatus as a seat, such as a boat seat. For example, a user may sit on mounting platform 110.

With further reference to FIG. 1, back support 115 is shown as an arc. Alternatively back support 115 can be substantially straight. However, the arc is typically more comfortable as it allows the back of a person to sit against back support 115 without significant pressure points that may occur with a straight back. It is also envisioned that back support 115 can extend above and/or below the plane of first arm 120, second arm 130 and/or mounting platform 110, for example to provide additional support to the standing person in space 190 or sitting on mounting platform 110.

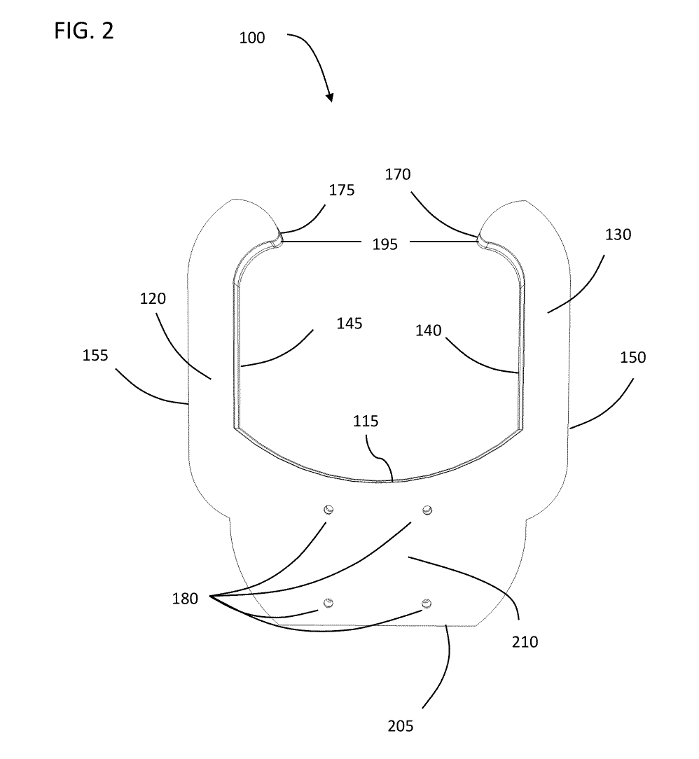

With further reference to FIG. 2, which is rotated 180° about the front/back axis relative to FIG. 1, second plate 205 is shown. Second plate 205 is substantially similar in shape as first plate 105 as shown in FIG. 1.

With further reference to FIGS. 1-6 first arm 120 and second arm 130 are shown in FIGS. 1-6 in a substantially parallel configuration, although slight deviations from parallel are contemplated. First personal positioning surface 140 and second personal positioning surface 145 are shown in a linear configuration. Alternatively one or both of first personal positioning surface 140 and second personal positioning surface 145 can be curved, for example as arc or complex curve, for example contiguous with first personal retention hook 170 and second personal retention hook 175, that can closely fit the waist of a person using standing support apparatus 100. Such curves can flow seamlessly with the curve of back support 115 or first personal retention hook 170 and second personal retention hook 175. Similarly, first outer surface 155 and/or second outer surface 155 can be linear, as shown, or curved.

In alternative embodiments, one or more of first arm 120 and second arm 130 are articulated, for example with a hinge, such that one or more of first arm 120 and second arm 130 can be opened to allow even easier access to space 190 as opposed to entry through opening 195. In such a situation, the articulation of one or more of first arm 120 and second arm 130 can be locked in the closed position, to prevent the person in space 190 from moving other than through opening 195. For example a linchpin can be used to secure the arm from movement.

First personal retention hook 170 and second personal retention hook 175 are configured to curve inward toward each other, essentially constricting space 190 to opening 195, such that the hips of a person are retained in space 190. The internal surfaces of personal retention hook 170 and second personal retention hook 175 are preferably arced, such as in quarter circle and the like, for example to sit comfortably against the persons hips.

In alternate embodiments, the first arm 120 and the second arm 130 are configured without the first personal retention hook 170 and second personal retention hook 175. The first arm 120 and the second arm 130 may be substantially straight, tapered, or curved. The end of the first arm 120 and the second arm 130 that form the through opening 195 may be rounded, square ended, tapered, or any suitable configuration. In the example, the standing support apparatus 100, with no personal retention hooks 170, 180, may provide little or no forward stability. That is, if the first arm 120 and the second arm 130 are tapered inward, even without the personal retention hooks 170, 180, some forward stability may be provided. In another example, if the first arm 120 and the second arm 130 are substantially straight and parallel, without the personal retention hooks 170, 180, no forward stability may be provided.

In some embodiments of support apparatus 100, disposed within mounting platform 110 are at least one, such as a plurality, for example four holes 180, for mounting support apparatus 100, for example to a preexisting pedestal, such as a boat seat pedestal. Alternatively, mounting platform 110 can provide a surface for mounting, such as mounting to a pedestal, using a fastener, such as a screw, nail, rivet and the like. For example a mounting plate, such as mounting plate having a spindle or other attachment, can be affixed to support apparatus 100 at mounting platform 110 by passing a fastener from the mounting plate into the mounting platform. For example where mounting platform 110 is comprised of wood, such as marine grade plywood, a wood screw can be used. In still other embodiments, a mounting plate can be affixed to support apparatus 100 at mounting platform 110 using an adhesive, such as those known to those of ordinary skill in the art.

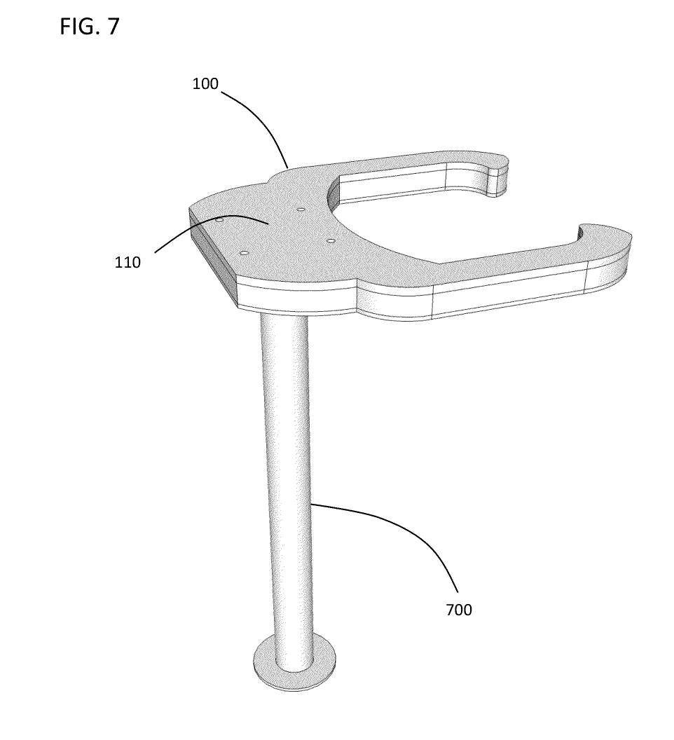

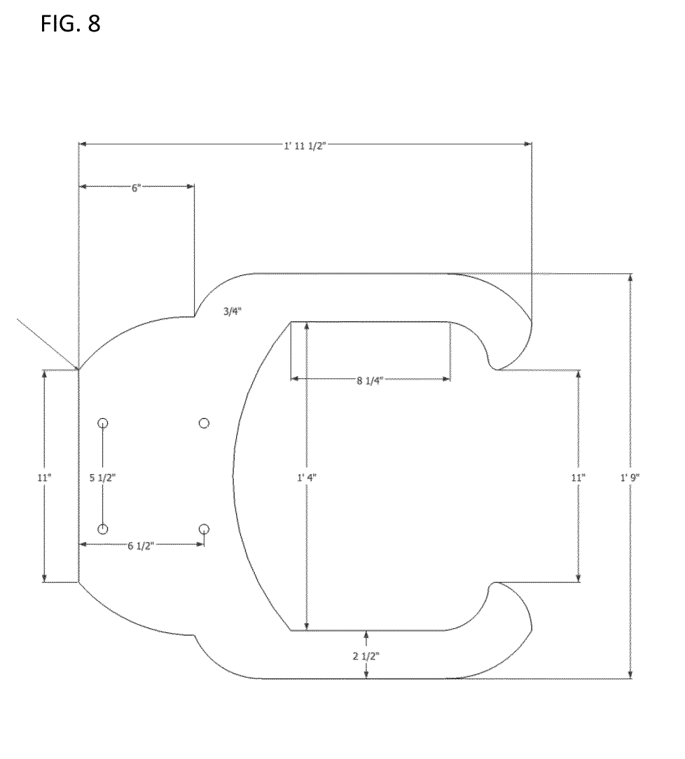

With reference to FIG. 6, in one embodiment standing support apparatus 100 is constructed of a composite of three pieces, first plate 105, second plate 205 and center support frame 305. As shown in the exploded view of FIG. 7, first plate 105 and second plate 205 are separated by center support frame 305. First plate 105 is coupled to center support frame 305 at a first side and second plate 205 is coupled to the center support frame at a second side, opposite the first side. Generally first plate 105, second plate 205, and center support frame 305 are of the same outline. In some embodiments, center spacer 305 is substantially hollow within the outline. A hollow center support frame can be used to reduce the weight of the apparatus, for example relative to a solid contrition. Alternatively, the disclosed apparatus can be made of a single piece.

Turning now to FIG. 7, standing support apparatus 100 can be attached to pedestal 700. The height and direction may be adjusted, for example using a commercially available swivel seat mount and expandable/collapsible pedestal. Height adjustment can be set so that the standing stability apparatus can be a seat.

Mounting stability apparatus 100 to a pedestal 700 is done by securing mounting platform 100 to pedestal 700, parallel to the level vehicle/watercraft surface, for example using a seat mounting bracket, such as a seat mounting bracket that has multiple degrees of freedom of adjustment. Thus, in some embodiments, standing support apparatus 100, comprises pedestal 700. The pedestal should be of sufficient height that the stability apparatus when in use will be at hip height. In some embodiments, the support apparatus has vertical adjustability, wherein the pedestal can be retained or locked at a specific height. In some embodiments, the standing support apparatus of has rotational adjustability about the axis of the pedestal. In some embodiments, the standing support apparatus can be retained or locked at a specific rotation. In some embodiments, the standing support apparatus has tilt adjustability and can be retained or locked at a specific tilt.

In certain embodiments, the standing support apparatus is covered or at least partially covered, for example to add both aesthetic appeal and to provide some degree of cushioning for the user. For example the standing support apparatus, can be at least partially covered, such as the arms, back support and mounting platform, with a fabric. In some examples, the covering fabric, can cover a cushioning material, such as, for exemplary purposes only, foam rubber. The fabric material is preferably waterproof

The disclosed standing stability apparatus can be made in multiple ways and using many different materials, for example wood, metal, rigid foam, carbon fiber, fiberglass, plastic, or combinations thereof. In one embodiment, a standing stability apparatus is made with wood, as wood is an inexpensive and readily available material. Additional functionality is afforded when commercially available seat mounts with swivel capability is used.

An exemplary method of making a disclosed standing stability apparatus out of wood includes first cutting a piece of plywood to produce a first plate, then repeating the cutting process again to produce a second plate, for example using a CNC router or other suitable machine, which results in two plywood pieces of the same shape. Next, a wood center support frame is cut to fit the outer edge of the plywood shaped in the form of the first plate and second plate. The center support frame is cut to fit flush with the outer edges of the first and second plant and is hollow in the middle.

Assembling the standing stability apparatus is completed by adhering, such as gluing, the top and bottom shaped plywood plates to the center support frame ensuring that all edges are flush. In some examples, before the adhesive, such as glue, dries, appropriately sized fasteners, such as wood screws, are used to further secure the shaped plywood plates to the center support frame at the joint where the adhesive, such as glue, was applied. Holes can then be drilled through the apparatus mounting platform that match the type seat mount to be used. The standing stability apparatus is complete and ready for mounting to a pedestal.

The standing stability apparatus can be further fitted with additional accessories. For example the standing stability apparatus can be configured to further include one or more of a fishing rod holder, a cup holder or a gear tray/tackle box.

In some embodiments, the standing stability apparatus includes a boat seat mount.

With reference to FIG. 8, shown is an exemplary dimensioned standing stability apparatus.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A standing support apparatus for a standing person, comprising:
a mounting platform, for mounting the seat to a pedestal;
a back support, configured for contacting a standing person;
a first arm terminating in a first personal retention hook; and
a second arm terminating in a second personal retention hook, wherein the back support, the first arm, the second arm, the first personal retention hook, and the second personal retention hook are mechanically coupled and define a space for the torso of a standing person at hip height and configured for retaining a standing person in the space.

2. The standing support apparatus of claim 1, wherein the standing support apparatus is comprised of a first plate and a second plate separated by a center support frame, and wherein the first plate is coupled to the center support frame at a first side and the second plate is coupled to the center support frame at a second side, opposite the first side.

3. The standing support apparatus of claim 2, wherein the first plate, second plate, and center support frame are of the same outline.

4. The standing support apparatus of claim 3, wherein the center support frame is substantially hollow within the outline.

5. The standing support apparatus of claim 3, wherein the center support frame comprises a wooden structure.

6. The standing support apparatus of claim 1, wherein the first arm and the second arm form an opening with no retention hooks.

7. The standing support apparatus of claim 1, wherein the back support is configured as an arc for contacting a standing person.

8. The standing support apparatus of claim 1, wherein the first arm and the second arm are substantially parallel.

9. The standing support apparatus of claim 1, wherein the first arm and the second arm are substantially the same length.

10. The standing support apparatus of claim 1, wherein the first personal retention hook and the second personal retention hook curve toward each other.

11. The standing support apparatus of claim 1, wherein the modified seat further comprises a covering.

12. The standing support apparatus of claim 11, wherein the modified seat further comprises padding under the covering.

13. The standing support apparatus of claim 1, further comprising a boat seat mount.

14. The standing support apparatus of claim 1, further comprising one or more of a fishing rod holder, a cup holder or a gear tray/tackle box

15. The standing support apparatus of claim 1, wherein one or more of the first arm and the second arm are articulated and can be retained or locked in the closed position.

16. The standing support apparatus of claim 1, further comprising a pedestal.

17. The standing support apparatus of claim 1, wherein support apparatus has vertical adjustability and wherein the pedestal can be retained or locked at a specific height.

18. The standing support apparatus of claim 1, wherein the support apparatus has rotational adjustability about the axis of the pedestal and wherein the pedestal can be retained or locked at a specific rotation.

19. The standing support apparatus of claim 1, wherein the support apparatus has tilt adjustability and wherein the pedestal can be retained or locked at a specific tilt.

20. A modified fishing seat, comprising:
a mounting platform, for mounting the seat to a pedestal;
a back support, configured for contacting a standing person;
a first arm; and
a second arm, wherein the first arm comprises a first personal retention hook and the second arm comprises a second personal retention hook, the back support, the first arm, the second arm, the first personal retention hook, and the second personal retention hook, defining a space for the torso of a standing person at hip height and configured for retaining a standing person in the space.
